(19) United States
(12) Patent Application Publication
(10) Pub. No.: US 2022/0411668 A1
(43) Pub. Date: Dec. 29, 2022

(54) ADHESIVE FILM FOR DISPLAY

(71) Applicant: INNOX Advanced Material Co., Ltd., Asan-si (KR)

(72) Inventors: Jae Hyeon CHO, Asan-si (KR); Hyeong Jin KIM, Asan-si (KR); Jong Geol LEE, Asan-si (KR); Myung Sup JUNG, Asan-si (KR)

(21) Appl. No.: 17/847,463

(22) Filed: Jun. 23, 2022

(30) Foreign Application Priority Data
Jun. 23, 2021 (KR) 10-2021-0081585

(51) Int. Cl. C09J 7/30; C09J 9/00; C09J 11/04; B32B 7/12; B32B 17/10; B32B 27/36; B32B 23/04; B32B 27/28; B32B 27/32; B32B 27/30

(52) U.S. Cl. CPC C09J 7/30; C09J 9/00; C09J 11/04; B32B 7/12; B32B 17/10; B32B 27/36; B32B 23/04; B32B 27/365; B32B 27/286; B32B 27/32; B32B 27/308; B32B 27/325; C08K 2003/2231

(57) ABSTRACT

An adhesive film for a display includes a first adhesive layer including an adhesive resin; a water-vapor barrier layer disposed on the first adhesive layer; a second adhesive layer disposed on the water-vapor barrier layer and including an adhesive resin; and an optical film disposed on the second adhesive layer, wherein at least one layer of the first adhesive layer or the water-vapor barrier layer contains at least one tungsten oxide selected from a group consisting of cesium-doped tungsten oxide (CWO; cesium-doped WO₃) and tungsten oxide (WO₃).

### CROSS-REFERENCE TO RELATED APPLICATION

This application claims priority from Korean Patent Application No. 10-2021-0081585 filed on Jun. 23, 2021 in the Korean Intellectual Property Office, and all the benefits accruing therefrom under 35 U.S.C. 119, the contents of which in its entirety are herein incorporated by reference.

### BACKGROUND

### Field

The present disclosure relates to an adhesive film for a display. More specifically, the present disclosure relates to an adhesive film for a display with improved reliability in a high temperature and high humidity environment while having excellent visible light transmittance and near-infrared ray absorbance.

### Related Art

Recently, in a display industry, there is a technical task of developing an adhesive film capable of absorbing and shielding near-infrared rays and improving reliability in high-temperature and high-humidity environments while achieving excellent transmittance of visible light.

In particular, since a metal oxide contained in an adhesive layer of the adhesive film to shield near-infrared rays exhibits a high water-vapor absorption, reliability of the layer is lowered in high-temperature and high-humidity environments. Thus, haze increases and thus visibility is lowered.

Therefore, it is necessary to develop an adhesive film with excellent reliability in which near-infrared shielding and visible light transmittance are maintained in high-temperature and high-humidity environments, and the haze in the visible light does not increase.

### SUMMARY

A purpose of the present disclosure is to provide an adhesive film for a display that has high near-infrared absorbance and visible light transmittance, maintains excellent reliability in high-temperature and high-humidity environments, and minimizes haze changes.

Purposes of the present disclosure are not limited to the above-mentioned purpose. Other purposes and advantages of the present disclosure that are not mentioned may be understood based on following descriptions, and may be more clearly understood based on embodiments of the present disclosure. Further, it will be easily understood that the purposes and advantages of the present disclosure may be realized using means shown in the claims and combinations thereof.

One aspect of the present disclosure provides an adhesive film for a display, the adhesive film comprising: a first adhesive layer including an adhesive resin; a water-vapor barrier layer disposed on the first adhesive layer; a second adhesive layer disposed on the water-vapor barrier layer and including an adhesive resin; and an optical film disposed on the second adhesive layer, wherein at least one layer of the first adhesive layer or the water-vapor barrier layer contains at least one tungsten oxide selected from a group consisting of cesium-doped tungsten oxide (CWO; cesium-doped WO₃) and tungsten oxide (WO₃).

In one implementation of the present disclosure, at least one layer of the water-vapor barrier layer, the second adhesive layer or the optical film may have a water-vapor transmission rate (WVTR) of 100 g/m²·day or smaller under 37° C. and 90% RH conditions.

In one implementation of the present disclosure, the water-vapor barrier layer may have the water-vapor transmission rate (WVTR) of 100 g/m²·day or smaller under 37° C. and 90% RH conditions.

In one implementation of the present disclosure, the water-vapor barrier layer may further contain a near-infrared ray absorbing dye.

In one implementation of the present disclosure, at least one of the first adhesive layer, the water-vapor barrier layer or the second adhesive layer may further contain indium tin oxide.

In one implementation of the present disclosure, at least one of the first adhesive layer, the water-vapor barrier layer or the second adhesive layer may further contain an ultraviolet (UV) ray absorber.

In one implementation of the present disclosure, the adhesive film may have transmittance of a near-infrared ray of a wavelength range of 700 nm exclusive to 1500 nm inclusive in a range of 5 to 50%, wherein the adhesive film may have transmittance of visible light of a wavelength range of 400 nm to 700 nm in a range of 80% or greater.

In one implementation of the present disclosure, the adhesive film may have haze in visible light of a wavelength range of 400 nm to 700 nm in a range of 2.0% or smaller.

The adhesive film for the display according to the present disclosure has high near-infrared absorbance and visible light transmittance, and maintains excellent reliability in high-temperature and high-humidity environments, and significantly lowers the haze.

The effect of the present disclosure is not limited to the above-mentioned effects, and another effect as not mentioned will be clearly understood by those skilled in the art from the following description. In addition to the above-described effects, specific effects of the present disclosure will be described together while describing specific details for carrying out the present disclosure below.

### BRIEF DESCRIPTION OF DRAWINGS

FIG. 1 shows a cross-section in which an adhesive film for a display according to an aspect of the present disclosure is formed on a cover window.

### DETAILED DESCRIPTIONS

Advantages and features of the present disclosure, and a method of achieving the advantages and features will become apparent with reference to embodiments described later in detail together with the accompanying drawings. However, the present disclosure is not limited to embodiments as disclosed below, but may be implemented in various different forms. Thus, these embodiments are set forth only to make the present disclosure complete, and to completely inform the scope of the present disclosure to those of ordinary skill in the technical field to which the present disclosure belongs, and the present disclosure is only defined by the scope of the claims.

A shape, a size, a ratio, an angle, a number, etc. disclosed in the drawings for describing the embodiments of the present disclosure are illustrative, and the present disclosure is not limited thereto. The same reference numerals refer to the same elements herein. Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

The terminology used herein is directed to the purpose of describing particular embodiments only and is not intended to be limiting of the present disclosure. As used herein, the singular constitutes “a” and “an” are intended to include the plural constitutes as well, unless the context clearly indicates otherwise. It will be further understood that the terms “comprise”, “including”, “include”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of the associated listed items. Expression such as “at least one of” when preceding a list of elements may modify an entirety of list of elements and may not modify the individual elements of the list. In interpretation of numerical values, an error or tolerance therein may occur even when there is no explicit description thereof.

In addition, it will also be understood that when a first element or layer is referred to as being present “on” a second element or layer, the first element may be disposed directly on the second element or may be disposed indirectly on the second element with a third element or layer being disposed between the first and second elements or layers. It will be understood that when an element or layer is referred to as being “connected to”, or “coupled to” another element or layer, it may be directly on, connected to, or coupled to the other element or layer, or one or more intervening elements or layers may be present. In addition, it will also be understood that when an element or layer is referred to as being “between” two elements or layers, it may be the only element or layer between the two elements or layers, or one or more intervening elements or layers may also be present.

Further, as used herein, when a layer, film, region, plate, or the like may be disposed “on” or “on a top” of another layer, film, region, plate, or the like, the former may directly contact the latter or still another layer, film, region, plate, or the like may be disposed between the former and the latter. As used herein, when a layer, film, region, plate, or the like is directly disposed “on” or “on a top” of another layer, film, region, plate, or the like, the former directly contacts the latter and still another layer, film, region, plate, or the like is not disposed between the former and the latter. Further, as used herein, when a layer, film, region, plate, or the like may be disposed “below” or “under” another layer, film, region, plate, or the like, the former may directly contact the latter or still another layer, film, region, plate, or the like may be disposed between the former and the latter. As used herein, when a layer, film, region, plate, or the like is directly disposed “below” or “under” another layer, film, region, plate, or the like, the former directly contacts the latter and still another layer, film, region, plate, or the like is not disposed between the former and the latter.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

In interpreting a numerical value, the value is interpreted as including an error range unless there is no separate explicit description thereof.

It will be understood that when an element or layer is referred to as being “connected to”, or “coupled to” another element or layer, it may be directly on, connected to, or coupled to the other element or layer, or one or more intervening elements or layers may be present. In addition, it will also be understood that when an element or layer is referred to as being “between” two elements or layers, it may be the only element or layer between the two elements or layers, or one or more intervening elements or layers may also be present.

The features of the various embodiments of the present disclosure may be partially or entirely combined with each other, and may be technically associated with each other or operate with each other. The embodiments may be implemented independently of each other and may be implemented together in an association relationship.

In descriptions of temporal relationships, for example, temporal precedent relationships between two events such as “after”, “subsequent to”, “before”, etc., another event may occur therebetween unless “directly after”, “directly subsequent” or “directly before” is not indicated.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present disclosure has been derived to solve a problem that tungsten oxide which may be contained in an adhesive film for a display so as to impart a function of absorbing and shielding near infrared rays, and a function of transmitting visible light therethrough to the adhesive film for the display is generally very vulnerable to water-vapor in high temperature and high humidity environments, so that reliability of the adhesive film is significantly lowered.

An adhesive film for a display according to an aspect of the present disclosure includes: a first adhesive layer including an adhesive resin; a water-vapor barrier layer disposed on the first adhesive layer; a second adhesive layer disposed on the water-vapor barrier layer and including an adhesive resin; and an optical film disposed on the second adhesive layer.

In this regard, at least one of the first adhesive layer or the water-vapor barrier layer may contain at least one tungsten oxide selected from a group consisting of cesium-doped tungsten oxide (CWO; cesium-doped WO₃) and tungsten oxide (WO₃).

Each of cesium doped tungsten oxide (CWO; cesium doped WO₃) and tungsten oxide (WO₃) may absorb light of a wavelength in a range of 800 nm exclusive to 1,500 nm inclusive.

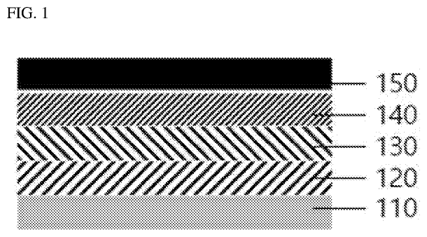

Based on a result of intensive research by the inventor of the present disclosure, the inventor has identified that when an adhesive layer included in the adhesive film for a display includes a plurality of adhesive layers, as shown in FIG. 1 such that a first adhesive layer 120 including an adhesive resin on a cover window 110, a water-vapor barrier layer 130 that may prevent water-vapor transmission is disposed on the first adhesive layer, at least one of the first adhesive layer or the water-vapor barrier layer contains at least one tungsten oxide selected from a group consisting of cesium-doped tungsten oxide (CWO; cesium-doped WO₃) and tungsten oxide (WO₃), a second adhesive layer 140 containing an adhesive resin is disposed on the water-vapor barrier layer, and an optical film 150 is disposed on the second adhesive layer 140, the water vapor transmission rate to tungsten oxide is significantly reduced. In this way, the present disclosure has been completed.

At least one of the water-vapor barrier layer, the second adhesive layer or the optical film has a water-vapor transmission rate (WVTR) of 100 g/m²·day or smaller under conditions of 37° C. and 90% RH in terms of an effect of reducing the water vapor transmission rate to tungsten oxide,

In particular, the water-vapor barrier layer preferably has the water-vapor transmission rate (WVTR) of 100 g/m²·day or smaller under the conditions of 37° C. and 90% RH. The water-vapor barrier layer more preferably has the water-vapor transmission rate (WVTR) of 70 g/m²·day or smaller under the conditions of 37° C. and 90% RH.

When the water-vapor transmission rate under 37° C. and 90% RH of the water-vapor barrier layer is smaller than or equal to 100 g/m².day, this may prevent water-vapor transmission into the water-vapor barrier layer and the first adhesive layer. As a result, the problem that the tungsten oxide is decomposed due to water-vapor, thereby reducing reliability may be removed. In particular, it is more preferable that the water-vapor transmission rate (WVTR) of the water-vapor barrier layer under 37° C. and 90% RH is 70 g/m²·day or smaller.

The water-vapor barrier layer may include an adhesive resin that satisfies a condition of a water-vapor transmission rate.

The adhesive resin used in each of the first adhesive layer, the water-vapor barrier layer, and the second adhesive layer may include at least one selected from a group consisting of a urethane resin, an acrylic resin, an epoxy resin, and a silicone resin.

The urethane resin may include urethane (meth)acrylate resin, 1,2-polybutadiene-terminated urethane (meth)acrylate resin, 1,4-polybutadiene-terminated urethane (meth)acrylate resin, polyester-based urethane (meth)acrylate resin, a polyether-based urethane (meth)acrylate resin, a product substituted with a hydrophilic group of each thereof, a hydrogenated product of each thereof, or a combination thereof.

The urethane (meth)acrylate resin may be prepared by reacting polyisocyanate, polyol, and (meth)acrylic acid with each other.

The polyisocyanate may include 2,4-tolylene diisocyanate, 2,6-tolylene diisocyanate, 4,4′-diphenylmethane diisocyanate, m-phenylene diisocyanate, xylylene diisocyanate, tetramethylene diisocyanate, hexamethylene diisocyanate, lysine diisocyanate ester, 1,4-cyclohexylene diisocyanate, 4,4′-dicyclohexylmethane diisocyanate, 3,3′-dimethyl-4,4′-biphenylene diisocyanate or a combination thereof.

The polyol may include polyester diol, polyether diol, polycaprolactone diol, polycarbonate diol, or a combination thereof.

The acrylic resin may include a monofunctional (meth)acrylate resin, a polyfunctional (meth)acrylate resin, or a combination thereof.

Examples of the monofunctional (meth)acrylate resin may include a polymer of at least one monomer selected from a group consisting of methyl (meth)acrylate, ethyl (meth)acrylate, propyl (meth)acrylate, butyl (meth)acrylate, 2-ethylhexyl (meth)acrylate, isooctyl (meth)acrylate, isodecyl (meth)acrylate, lauryl (meth)acrylate, stearyl (meth)acrylate, phenyl (meth)acrylate, cyclohexyl (meth)acrylate, dicyclopentanyl (meth)acrylate, dicyclopentenyl (meth)acrylate, dicyclopentenyloxyethyl (meth)acrylate, isobornyl (meth)acrylate, methoxylated cyclodecatriene (meth)acrylate, 2-hydroxyethyl (meth)acrylate, 2-hydroxypropyl (meth)acrylate, 3-hydroxypropyl (meth)acrylate, 4-hydroxybutyl (meth)acrylate, tetrahydrofurfuryl (meth)acrylate, 2-hydroxy-3-phenoxypropyl (meth)acrylate, glycidyl (meth)acrylate, caprolactone-modified tetrahydrofurfuryl (meth)acrylate, 3-chloro-2-hydroxypropyl (meth)acrylate, N,N-dimethylaminoethyl (meth)acrylate, N,N-diethylaminoethyl (meth)acrylate, t-butylaminoethyl (meth)acrylate, ethoxycarbonylmethyl (meth)acrylate, phenol ethylene oxide modified acrylate, phenol (2 moles of ethylene oxide modified) acrylate, phenol (4 moles of ethylene oxide modified) acrylate, paracumylphenol ethylene oxide modified acrylate, nonylphenol ethylene oxide modified acrylate, nonylphenol (4 moles of ethylene oxide modified) acrylate, nonylphenol (modified by 8 moles of ethylene oxide) acrylate, nonylphenol (modified by 2.5 moles of propylene oxide) acrylate, 2-ethylhexylcarbitol acrylate, ethylene oxide-modified phthalic acid (meth)acrylate, ethylene oxide-modified succinic acid (meth)acrylate, trifluoroethyl (meth)acrylate, acrylic acid, methacrylic acid, maleic acid, fumaric acid, ω-carboxy-polycaprolactone mono (meth)acrylate, phthalic acid monohydroxyethyl (meth)acrylate, (meth)acrylic acid dimer, β-(meth)acroyloxyethyl hydrogen succinate, n-(meth)acryloyloxyalkyl hexahydrophthalimide, and a product substituted with a hydrophilic group of each thereof.

The multifunctional (meth)acrylate may include a bifunctional(meth)acrylate, a trifunctional(meth)acrylate, a tetrafunctional or greater (meth)acrylate, or combinations thereof.

The bifunctional (meth)acrylate may include a polymer of at least one monomer selected from a group consisting of 1,3-butylene glycol di(meth)acrylate, 1,4-butanediol di(meth)acrylate, 1,6-hexadiol di(meth)acrylate, 1,9-nonandiol di(meth)acrylate, neopentyl glycol di(meth)acrylate, dicyclopentanyldi(meth)acrylate, 2-ethyl-2-butyl-propanediol(meth)acrylate, neopentyl glycol-modified trimethylolpropanedi(meth)acrylate, stearic acid-modified pentaerythritol diacrylate, polypropylene glycol di(meth)acrylate, 2,2-bis(4-(meth)acryloxydiethoxyphenyl)propane, 2,2-bis(4-(meth)acryloxypropoxyphenyl)propane, 2,2-bis(4-(meth)acryloxytetraethoxyphenyl)propane, and a product substituted with a hydrophilic group of each thereof.

The trifunctional (meth)acrylate may include a polymer of at least one monomer selected from a group consisting of trimethylolpropane tri(meth)acrylate, trisRmeth)acryloxyethyllisocyanurate, and a product substituted with a hydrophilic group of each thereof.

The tetrafunctional or greater (meth)acrylate may include a polymer of at least one monomer selected from a group consisting of dimethylolpropane tetra(meth)acrylate, pentaerythritol tetra(meth)acrylate, pentaerythritol ethoxytetra(meth)acrylate, dipentaerythritol penta(meth)acrylate, dipentaerythritol hexa(meth)acrylate, and product substituted with a hydrophilic group of each thereof.

The epoxy resin may include a bisphenol-based epoxy resin, a biphenyl-based epoxy resin, a naphthalene-based epoxy resin, a florene-based epoxy resin, a phenol novolak-based epoxy resin, a cresol novolak-based epoxy resin, a trishydroxylphenylmethane-based epoxy resin, a tetraphenylmethane-based epoxy resin, or combinations thereof.

In this regard, the bisphenol-based epoxy resin may include a bisphenol A type epoxy resin, a bisphenol F type epoxy resin, a bisphenol S type epoxy resin, a hydrogenated bisphenol A type epoxy resin, and a bisphenol AF type epoxy resin. Currently commercially available epoxy resin products may include, as bisphenol A type epoxy resins, YD-020, YD-020L, YD-019K, YD-019, YD-017H, YD-017R, YD-017, YD-014, YD-014ER, YD-013K, YD-012, YD-011H, YD-011S, YD-011, etc. from Kukdo Chemical; as cresol novolak-based epoxy resin, YDCN-500-80PCA60, YDCN-500-80PBC60, YDCN-500-90PA75, YDCN-500-90P, YDCN-500-80P, YDCN-500-10P, YDCN-500-8P, YDCN-500-7P, YDCN-500-5P, YDCN-500-4P, YDCN-500-1P from Kukdo Chemical; as cresol novolak-based epoxy resin, EOCN-102S, EOCN-103S, EOCN-104S, EOCN-1012, EOCN-1025, EOCN-1027 from Japan Explosives Co., Ltd.; and as cresol novolak-based epoxy resin, YDCN-701, YDCN-702, YDCN-703, YDCN-704, YDCN-701P, YDCN-702P, YDCN-703P, YDCN-704P, YDCN-701S, YDCN-702S, YDCN-703S, etc. from Nippon Steel & Sumikin Chemical. Further, examples of phenol novolak based epoxy resins may include YDPN-638A80, YDPN-644, YDPN-637, YDPN-636, YDPN-638, and YDPN-631, etc.

The silicone resin may include a solvent-added resin, a solvent condensed resin, a solvent ultraviolet-curable resin, a solvent-free addition-type resin, a solvent-free condensation-type resin, a solvent-free ultraviolet-curable resin, a solvent-free electron beam-curable resin, or combinations thereof.

The water-vapor barrier layer disposed on the first adhesive layer may further contain a near-infrared ray absorbing dye.

The near-infrared ray absorbing dye may have a maximum absorption in a wavelength band in a range of 800 nm exclusive to 1,200 nm inclusive.

The near-infrared ray absorbing dye may include at least one selected from a group consisting of a dimonium dye, a dithiol metal complex dye, a cyanine dye, a phthalocyanine dye, a naphthalocyanine dye, a porphyrin dye, a benzoporphyrin dye, a squarylium dye, an anthraquinone dye, and a croconium dye.

Examples of the dimonium dye may include FND100 (Ukseung Chemical), EPOLIGHT1178 (Epolin), CIR-1085 (Kalite), and PDC-220 (Nippon Chemical).

Examples of the cyanine dye may include Panax Y-2046 (Ukseung Chemical).

Examples of the dithiol metal complex dye may include ADS845MC and ADS920MC from American Dye Source.

Further, at least one of the first adhesive layer, the water-vapor barrier layer, or the second adhesive layer of the adhesive film for the display according to the present disclosure may further contain indium tin oxide.

The indium tin oxide may absorb light of a long wavelength of 1,200 nm to 1,500 nm.

Further, at least one of the first adhesive layer, the water-vapor barrier layer, or the second adhesive layer of the adhesive film for the display according to the present disclosure may further contain a UV ray absorber.

The UV ray absorber serves to suppress occurrence of a photo-coloring phenomenon in which a temperature of the adhesive film is increased due to UV rays such that properties of the film are changed or transmittance of the film is decreased due to UV rays for a long period of time. Accordingly, preferably, the UV ray absorber may be contained in the first adhesive layer that may be disposed on the cover window.

The UV ray absorber may include an organic UV ray absorber such as benzotriazole compounds, benzophenone compounds, and salicylic acid compounds, triazine compounds, benzotriazolyl compounds, and benzoyl compounds, an inorganic UV ray absorber such as zinc oxide, titanium oxide, and cerium oxide, or combinations thereof. Preferably, the ultraviolet (UV) ray absorber may include a benzotriazole compound, a benzophenone compound, or a combination thereof, so that the transmittance of visible light may be maintained at a high level and at the same time, durability against ultraviolet light may be improved.

The adhesive film for the display according to the present disclosure may preferably contain 15 parts by weight or smaller of the UV ray absorber, more preferably 10 parts by weight or smaller, and most preferably, 5 parts by weight or smaller relative to 100 parts by weight of the adhesive resin. The UV-blocking effect increases as a content of the UV ray absorber increases. However, when the content thereof exceeds of 15 parts by weight relative to 100 parts by weight of the adhesive resin, transparency and designability of the film may be deteriorated due to precipitation of the UV ray absorber.

Each of the tungsten oxide of CWO (cesium-doped WO₃) and WO₃ (tungsten oxide) preferably has a nanopowder form. When at least one of the first adhesive layer, the water-vapor barrier layer, or the second adhesive layer of the adhesive film for the display according to the present disclosure contains indium tin oxide, indium tin oxide may be present in a nanopowder form.

Preferably, in order to maintain the transparency and secure visibility in the visible light region of the adhesive film at high efficiency, a particle diameter of each of the indium tin oxide particle, CWO (cesium-doped WO₃) particle, or WO₃ (tungsten oxide) particle may be in a range of 10 nm to 100 nm.

At least one tungsten oxide selected from a group consisting of the cesium-doped tungsten oxide (CWO; cesium-doped WO₃) and tungsten oxide (WO₃), the indium tin oxide and the near-infrared ray absorbing dye may belong to a near-infrared ray blocker. In this regard, the adhesive film may contain 0.01 to 20 parts by weight of the near-infrared blocker based on 100 parts by weight of the adhesive resin. When the content of the near-infrared ray blocking agent is smaller than 0.01 parts by weight, the adhesive film may not sufficiently exhibit the near-infrared ray blocking effect. When the content of the near-infrared blocker exceeds 20 parts by weight, a decrease in transparency of the film, deterioration of physical properties of the film, and the like may occur.

A composition for forming at least one of the first adhesive layer, the water-vapor barrier layer, or the second adhesive layer may further contain a thermal curing agent.

The thermal curing agent may serve to promote thermal curing of the composition for forming the adhesive film for the display according to the present disclosure including the adhesive resin and the near-infrared ray blocking agent.

The thermal curing agent may include iodonium salts such as diphenyliodonium hexafluorophosphate, diphenyliodonium hexafluoroantimonate, diphenyliodonium tetrafluoroborate, diphenyliodonium tetrakis(pentafluorophenyl)borate, bis(dodecylphenyl)iodonium hexafluorophosphate, bis(dodecylphenyl)iodonium hexafluoroantimonate, bis(dodecylphenyl)iodonium tetrafluoroborate, bis(dodecylphenyl)iodonium tetrakis(pentafluorophenyl)borate, 4-methylphenyl-4-(1-methylethyl)phenyliodonium hexafluorophosphate, 4-methylphenyl-4-(1-methylethyl)phenyliodonium hexafluoroantimonate, 4-methylphenyl-4-(1-methylethyl)phenyliodonium tetrafluoroborate, 4-methylphenyl-4-(1-methylethyl)phenyliodonium tetrakis(pentafluorophenyl)borate, 4-methoxydiphenyliodonium hexafluorophosphate, bis(4-methylphenyl)iodonium hexafluorophosphate, bis(4-t-butylphenyl)iodonium hexafluorophosphate and bis(dodecylphenyl)iodoniumtricumyliodonium hexafluorophosphate; sulfonium salts such as triallyl sulfonium hexafluoro antimonate; phosphonium salts such as triphenylpyrenylmethylphosphonium salt; (η6-benzene)(η5-cyclopentadienyeiron(II) hexafluoroantimonate; combination of o-nitrobenzylsilyl ether and aluminum acetylacetonate; combination of silsesquioxane and aluminum acetylacetonate; melamine based resin; organic peroxides (e.g. ketone peroxide, peroxy ketal, diacyl peroxide, peroxy ester, peroxydicarbonate, etc.), lewis acid (boron trifluoride, zinc chloride, aluminum chloride, iron chloride, tin chloride, etc.), azo compounds (azobisisobutyronitrile, 1,1′-azobis(cyclohexanecarbonitrile), etc.), acids (organic acids or sulfonium salt-based acid generators that generate acids via low temperature heating, etc.), bases (polyamines such as aliphatic polyamines, amine compounds such as imidazole, hydrazide and ketimine, compounds that generate amine compounds via low temperature heating, etc.), polyamide resin, polymercaptan, platinum group metal compound or complex thereof (platinum chloride (IV), chloroplatinic acid hexahydrate, bis(alkynyl)bis(triphenylphosphine)platinum complex, etc.), or combinations thereof. Commercially available products of the thermal curing agent may include 45S (Burim Chemical), DS-HF 10929TKI CATALYST (Teikoku Ink Preparation Co., Ltd., melamine resin).

It is preferable that the thermal curing agent be contained in an amount of 10 parts by weight or smaller based on 100 parts by weight of the adhesive resin. When the content of the thermal curing agent exceeds 10 parts by weight, this may cause deterioration of transparency of the film and deterioration of mechanical properties of the film.

A composition for forming at least one of the first adhesive layer, the water-vapor barrier layer, and the second adhesive layer may further contain at least one of a photopolymerization initiator, a light stabilizer, and an antioxidant.

The photopolymerization initiator serves to accelerate curing using UV irradiation.

The photopolymerization initiator may include benzophenone or a derivative thereof, benzyl or a derivative thereof, anthraquinone or a derivative thereof, benzoin, benzoin derivatives such as benzoin methyl ether, benzoin ethyl ether, benzoin propyl ether, benzoin isobutyl ether and benzyl dimethyl ketal, acetophenone derivatives such as diethoxyacetophenone, 4-t-butyltrichloroacetophenone, 2-dimethylaminoethylbenzoate, p-dimethylaminoethylbenzoate, diphenyldisulfide, thioxanthone and derivatives thereof, campoquinone, campoquinone derivatives such as 7,7-dimethyl-2,3-dioxobicyclo[2.2.1]heptane-1-carboxylic acid, 7,7-dimethyl-2,3-dioxobicyclo[2.2.1]heptane-1-carboxy-2-bromoethylester, 7,7-dimethyl-2,3-dioxobicyclo[2.2.1]heptane-1-carboxy-2-methylester, 7,7-dimethyl-2,3-dioxobicyclo[2.2.1]heptane-1-carboxylic acid chloride; alpha-aminoalkylphenone derivatives such as 2-methyl-1-[4-(methylthio)phenyl]-2-morpholinopropan-1-one, 2-benzyl-2-dimethylamino-1-(4-morpholinophenyl)-butanone-1, acylphosphine oxide derivatives such as benzoyldiphenylphosphine oxide, 2,4,6-trimethylbenzoyldiphenylphosphine oxide, benzoyldiethoxyphosphine oxide, 2,4,6-trimethylbenzoyldimethoxyphenylphosphine oxide and 2,4,6-trimethylbenzoyldiethoxyphenylphosphine oxide; or combinations thereof.

It is preferable that a content of the photopolymerization initiator is 10 parts by weight or smaller based on 100 parts by weight of the adhesive resin. When the content of the photopolymerization initiator exceeds 10 parts by weight, visible light transmittance may be deteriorated due to unreacted materials.

The light stabilizer may suppress occurrence of the light coloring phenomenon. When the light stabilizer is used together with the UV ray absorber, the light stabilizer may prevent deterioration of the UV ray absorber and thus contribute to maintaining the performance of the UV ray absorber.

The light stabilizer may include a hindered amine light stabilizer (HALs). In one example, the HALs may include bis(2,2,6,6-tetramethyl-4-piperidyl)sebacate, bis(1,2,2,6,6-pentamethyl-4-piperidyl)sebacate, 1-[2-[3-(3,5-t-butyl-4-hydroxyphenyl)propionyloxy[ethyl]-4-[3-(3,5-di-t-butyl-4-hydroxyphenyl)propionyloxy]-2,2,6,6-tetramethylpiperidine, 4-benzoyloxy-2,2,6,6-tetramethylpiperidine, 8-acetyl-3-dodecyl-7,7,9,9-tetramethyl-1,3,8-triazaspiro[4,5]decane-2,4-dione, bis-(1,2,2,6,6-pentamethyl-4-piperidyl)-2-(3,5-di-t-butyl-4-hydroxybenzyl)-2-n-butylmalonate, tetrakis(1,2,2,6,6-pentamethyl-4-piperidyl)-1,2,3,4-butanetetracarboxylate), tetrakis(2,2,6,6-tetramethyl-4-piperidyl)-1,2,3,4-butanetetracarboxylate), (mixed 1,2,2,6,6-pentamethyl-4-piperidyl/tridecyl)-1,2,3,4-butanetetracarboxylate, mixed{1,2,2,6,6-pentamethyl-4-piperidyl/β,β,β′,β′-tetramethyl-3,9-[2,4,8,10-tetraoxaspiro (5,5)undecane]diethyl}-1,2,3,4-butanetetracarboxylate, (mixed 2,2,6,6-tetramethyl-4-piperidyl/tridecyl)-1,2,3,4-butanetetracarboxylate, mixed{2,2,6,6-tetramethyl-4-piperidyl/β,β,β′,β′-tetramethyl-3,9-[2,4,8,10-tetraoxaspiro(5,5)undecane]diethyl}-1,2,3,4-butanetetracarboxylate,2,2,6,6-tetramethyl-4-piperidyl methacrylate, 1,2,2,6,6-pentamethyl-4-piperidyl methacrylate, poly[(6-(1,1,3,3-tetramethylbutyl)imino-1,3,5-triazine-2,4-diyl)][(2,2,6,6-tetramethyl-4-piperidyl)imino]hexamethylene[(2,2,6,6-tetramethyl-4-piperidyl)iminol], polymer of dimethyl succinate and 4-hydroxy-2,2,6,6-tetramethyl-1-piperidineethanol, N,N′,N″,N′″-tetrakis-(4,6-Bis-(Butyl-(N-methyl-2,2,6,6-tetramethylpiperidin-4-yl)amino)-triazin-2-yl)-4,7-diazadecane-1,10-diamine, polycondensate of dibutylamine-1,3,5-triazine-N,N′-bis(2,2,6,6-tetramethyl-4-piperidyl-1,6-hexamethylenediamine and N-(2,2,6,6-tetramethylpiperidyl)butylamine, and decanoic acid bis(2,2,6,6-tetramethyl-1-(octyloxy)-4-piperidyl)ester.

An amount of the light stabilizer is preferably 15 parts by weight or smaller, and more preferably 5 parts by weight or smaller, based on 100 parts by weight of the adhesive resin. When a content of the light stabilizer exceeds 15 parts by weight, this may cause problems such as deterioration of the transparency of the film.

The antioxidant suppresses oxidation and deterioration of the adhesive film, thereby improving the weather resistance of the adhesive film.

A type of the antioxidant may include a phenol-based antioxidant, a sulfur-based antioxidant, and a phosphorus-based antioxidant. Specific examples of the antioxidant may include 2,6-di-t-butyl-p-cresol, butylated hydroxyanisole, 2,6-di-t-butyl-4-ethylphenol, stearyl-β-(3,5-di-t-butyl-4-hydroxyphenyl)propionate, 2,2′-methylenebis-(4-methyl-6-butylphenol), 2,2′-methylene bis-(4-ethyl-6-t-butylphenol), 4,4′-Butylidene-bis-(3-methyl-6-t-butylphenol), 1,1,3-tris-(2-methyl-hydroxy-5-t-butylphenyl)butane, tetrakis[methylene-3-(3′,5′-butyl-4-hydroxyphenyl)propionate]methane, 1,3,3-tris-(2-methyl-4-hydroxy-5-t-butyl phenol)butane, 1,3,5-trimethyl-2,4,6-tris(3,5-di-t-butyl-4-hydroxybenzyl)benzene, bis(3,3′-t-butylphenol)butyric acid glycol ester and isooctyl-3-(3,5-di-t-butyl-4-hydroxyphenyl)propionate.

The antioxidant is preferably contained in an amount of 10 parts by weight or smaller, and more preferably in an amount of 5 parts by weight or smaller, relative to 100 parts by weight of the adhesive resin. When the content of the antioxidant exceeds 10 parts by weight, this may cause problems such as decrease in the visible light transmittance of the film.

Further, the composition for forming the adhesive film for the display according to the present disclosure may further contain a polymerization inhibitor; various elastomers, inorganic fillers; solvent; extender; reinforcement agent; plasticizer; thickener; additional dye; pigment; flame retardant; silane coupling agent; surfactants or combinations thereof if necessary in order to achieve the effects of the present disclosure.

The polymerization inhibitor may include methylhydroquinone, hydroquinone, 2,2-methylene-bis(4-methyl-6-tertbutylphenol), catechol, hydro-8-quinone monomethyl ether, mono-tertbutylhydroquinone, 2,5-di-tertbutylhydroquinone, p-benzoquinone, 2,5-diphenyl-p-benzoquinone, 2,5-di-tertbutyl-p-benzoquinone, picric acid, citric acid, phenothiazine, tertbutylcatechol, 2-butyl-4-hydroxyanisole, 2,6-di-tertbutyl-p-cresol, and the like. The various elastomers may include acrylic rubber, urethane rubber, acrylonitrile-butadiene-styrene rubber, and the like.

The optical film disposed on the second adhesive layer of the adhesive film for the display according to the present disclosure may include one selected from a group consisting of a polyethylene terephthalate (PET) film, a triacetyl cellulose (TAC) film, a cycloolefin polymer (COP) film, a polycarbonate (PC) film, a polyethersulfone (PES) film, a polypropylene (PP) film, and an acryl film.

The adhesive film for the display according to the present disclosure may have near-infrared ray transmittance of 5 to 50% in a wavelength range of 700 nm exclusive to 1500 nm inclusive.

Further, the adhesive film for the display according to the present disclosure may have visible light transmittance of 80% or greater in a wavelength range of 400 nm to 700 nm.

A spectral wavelength of sunlight is an intrinsic property of a material. In general, the ultraviolet wavelength band may be in a range of 280 nm to less than 400 nm, the visible light wavelength band may be in a range of 400 nm to 700 nm, and the near infrared ray wavelength band may be in a range of 700 nm exclusive to 1,500 nm inclusive. In particular, a region affecting visibility may be a range of 400 nm to 700 nm and may be visually recognized as red, green, and blue.

The metal oxide nano powder or the near-infrared ray absorbing dye included in the near-infrared ray blocking agent of the adhesive film for the display according to the present disclosure may block near-infrared rays in a wavelength range of 700 nm exclusive to 1,500 nm inclusive. Accordingly, the adhesive film for the display according to the present disclosure may selectively transmit therethrough only visible light in a wavelength band of 400 nm to 700 nm of the spectral wavelength of sunlight. That is, the adhesive film for display according to the present disclosure may effectively block the near-infrared wavelength of sunlight, and may exhibit the visible light transmittance in the wavelength band of 400 nm to 700 in a range of 80% or greater. Thus, the visibility may be effectively improved.

Further, the adhesive film for the display according to the present disclosure preferably has a haze of 2.0% or smaller, more preferably 1.0% or smaller in visible light of a wavelength in a range of 400 to 700. The haze is measured based on the ASTM D 1003 method using an NDH-7000 (Hazemeter) measuring device.

Hereinafter, a configuration and an effect of the present disclosure will be described in more detail based on a preferred example of the present disclosure. However, this example is presented as a preferred embodiment of the present disclosure, and should not be construed as limiting the present disclosure in any way.

Contents as not described herein will be omitted because those skilled in the art may technically infer the contents sufficiently.

### Preparation Example

### Present Example 1

Composition solutions for the first adhesive layer, the water-vapor barrier layer, and the second adhesive layer were prepared based on compositions and contents shown in Table 1 below, respectively. Each of the composition solutions of the first adhesive layer, the water-vapor barrier layer and the second adhesive layer was applied to a release surface of each release liner so as to have a thickness of each of the layers shown in Table 1, and was dried at 120° C. for 5 minutes, thereby preparing each of the layers. Then, the second adhesive layer, the water-vapor barrier layer, and the first adhesive layer were sequentially laminated in this order on a LR TAC film as an optical low-reflection film. Then, the release liner was removed to prepare an adhesive film. The adhesive film was laminated on an AR Glass of a thickness of 4850 μm as a cover window. The water-vapor transmission rate (WVTR) of each of the layers under conditions of 37° C. and 90% RH was measured using a ASTM F 1249 method.

TABLE 1

| | | | Content | | |
|---|---|---|---|---|---|
| | | | (parts by | Thickness | |
| Layer | Composition | Material | weight) | (μm) | WVTR |
| Film | Optical | LR TAC | — | 72 | 320.1 |
| | low-reflection | film | | | |
| | film | | | | |
| Second | Adhesive resin | BA8900 | 100 | 25 | 110.8 |
| adhesive | Additive 1 | Tetrad-X | 5.0 | | |
| layer | Additive 2 | C-ITO | 3.0 | | |
| Water-vapor | Adhesive resin | Elvacite | 100 | 10 | 63.0 |
| barrier layer | | 2051 | | | |
| | Additive 1 | CTO-2-2 | 12.5 | | |
| | Additive 2 | Panax | 1.0 | | |
| | | Y-2046 | | | |
| First | Adhesive resin | BA8900 | 100 | 25 | 110.8 |
| adhesive | Additive 1 | Tetrad-X | 5.0 | | |
| layer | Additive 2 | UV-1990 | 3.0 | | |
| Substrate | Glass | AR Glass | — | 4850 | ~0 |

### Present Example 2

An adhesive film was prepared in the same manner as that in Present Example 1, except that Panax Y-2046 was excluded from a composition solution for forming the water-vapor barrier layer as shown in Table 2 below.

TABLE 2

| | | | Content | | |
|---|---|---|---|---|---|
| | | | (parts by | Thickness | |
| Layer | Composition | Material | weight) | (μm) | WVTR |
| Film | Optical | LR TAC | — | 72 | 320.1 |
| | low-reflection | film | | | |
| | film | | | | |
| Second | Adhesive resin | BA8900 | 100 | 25 | 110.8 |
| adhesive | Additive 1 | Tetrad-X | 5.0 | | |
| layer | Additive 2 | C-ITO | 3.0 | | |
| Water-vapor | Adhesive resin | Elvacite | 100 | 10 | 63.0 |
| barrier layer | | 2051 | | | |
| | Additive 1 | CTO-2-2 | 12.5 | | |
| First | Adhesive resin | BA8900 | 100 | 25 | 110.8 |
| adhesive | Additive 1 | Tetrad-X | 5.0 | | |
| layer | Additive 2 | UV1990 | 3.0 | | |
| Substrate | Glass | AR Glass | — | 4850 | ~0 |

### Present Example 3

An adhesive film was prepared in the same manner as that in Present Example 2, except that, as shown in Table 3 below, an adhesive resin in the composition solution for forming the water-vapor barrier layer included Elvacite 2021C instead of Elvacite 2051.

TABLE 3

| | | | Content | | |
|---|---|---|---|---|---|
| | | | (parts by | Thickness | |
| Layer | Composition | Material | weight) | (μm) | WVTR |
| Film | Optical | LR TAC | — | 72 | 320.1 |
| | low-reflection | film | | | |
| | film | | | | |
| Second | Adhesive resin | BA8900 | 100 | 25 | 110.8 |
| adhesive | Additive 1 | Tetrad-X | 5.0 | | |
| layer | Additive 2 | C-ITO | 3.0 | | |
| Water-vapor | Adhesive resin | Elvacite | 100 | 10 | 88.8 |
| barrier layer | | 2021C | | | |
| | Additive 1 | CTO-2-2 | 12.5 | | |
| First | Adhesive resin | BA8900 | 100 | 25 | 110.8 |
| adhesive | Additive 1 | Tetrad-X | 5.0 | | |
| layer | Additive 2 | UV1990 | 3.0 | | |
| Substrate | Glass | AR Glass | — | 4850 | ~0 |

### Present Example 4

An adhesive film was prepared in the same manner as that in Present Example 1, except that, as shown in Table 4 below, CTO-2-2 was excluded from the composition solution for forming the water-vapor barrier layer, and CTO-2-2 was added to the first adhesive layer.

TABLE 4

| | | | Content | | |
|---|---|---|---|---|---|
| | | | (parts by | Thickness | |
| Layer | Composition | Material | weight) | (μm) | WVTR |
| Film | Optical | LR TAC | — | 72 | 320.1 |
| | low-reflection | film | | | |
| | film | | | | |
| Second | Adhesive resin | BA8900 | 100 | 25 | 110.8 |
| adhesive | Additive 1 | Tetrad-X | 5.0 | | |
| layer | Additive 2 | C-ITO | 3.0 | | |
| Water-vapor | Adhesive resin | Elvacite | 100 | 10 | 63.0 |
| barrier layer | | 2051 | | | |
| | Additive 1 | Panax | 1.0 | | |
| | | Y-2046 | | | |
| First | Adhesive resin | BA8900 | 100 | 25 | 110.8 |
| adhesive | Additive 1 | Tetrad-X | 5.0 | | |
| layer | Additive 2 | UV1990 | 3.0 | | |
| | Additive 3 | CTO-2-2 | 5.0 | | |
| Substrate | Glass | AR Glass | — | 4850 | ~0 |

### Comparative Example 1

An adhesive film was prepared in the same manner as that in Present Example 4, except that a layer structure of the adhesive film was modified as shown in Table 5 below. A first adhesive layer of Comparative Example 1 corresponds to a second adhesive layer of Present Example 4. A second adhesive layer of Comparative Example 1 corresponds to a first adhesive layer of Present Example 4.

TABLE 5

| | | | Content | | |
|---|---|---|---|---|---|
| | | | (parts by | Thickness | |
| Layer | Composition | Material | weight) | (μm) | WVTR |
| Film | Optical | LR TAC | — | 72 | 320.1 |
| | low-reflection | film | | | |
| | film | | | | |
| Second | Adhesive resin | BA8900 | 100 | 25 | 110.8 |
| adhesive | Additive 1 | Tetrad-X | 5.0 | | |
| layer | Additive 2 | UV1990 | 3.0 | | |
| | Additive 3 | CTO-2-2 | 5.0 | | |
| Water-vapor | Adhesive resin | Elvacite | 100 | 10 | 88.8 |
| barrier layer | | 2051 | | | |
| | Additive 1 | Panax | 1.0 | | |
| | | Y-2046 | | | |
| First | Adhesive resin | BA8900 | 100 | 25 | 110.8 |
| adhesive | Additive 1 | Tetrad-X | 5.0 | | |
| layer | Additive 2 | C-ITO | 3.0 | | |
| Substrate | Glass | AR Glass | — | 4850 | ~0 |

### Comparative Example 2

An adhesive film was prepared in the same manner as that in Present Example 1. However, as shown in Table 6 below, the adhesive film was prepared as a single layer. That is, the adhesive film was not divided into the first adhesive layer, the water-vapor barrier layer, and the second adhesive layer.

TABLE 6

| | | | Content | | |
|---|---|---|---|---|---|
| | | | (parts by | Thickness | |
| Layer | Composition | Material | weight) | (μm) | WVTR |
| Film | Optical | LR TAC | — | 72 | 320.1 |
| | low- | film | | | |
| | reflection | | | | |
| | film | | | | |
| Adhesive | Adhesive | BA8900 | 100 | 25 | 134 |
| layer | resin | | | | |
| | Additive 1 | Tetrad-X | 5.0 | | |
| | Additive 2 | CTO-2-2 | 5.0 | | |
| | Additive 3 | UV1990 | 3.0 | | |
| | Additive 4 | Panax | 0.4 | | |
| | | Y-2046 | | | |
| | Additive 5 | C-ITO | 3.0 | | |
| Substrate | Glass | AR Glass | — | 4850 | ~0 |

The materials used in Present Example 1, Present Example 2, Present Example 3, Present Example 4, Comparative Example 1, and Comparative Example 2 are shown in Table 7 below.

TABLE 7

| | | Chemical name or general | |
|---|---|---|---|
| Name | Material | name | Producer |
| AR Glass | Glass | Anti-Reflection Glass | UID company |
| BA8900 | Adhesive | Acrylic Copolymer | BURIM |
| | resin | (Copolymer obtained by | Chemical |
| | | copolymerizing butyl acrylate | |
| | | (BA), ethyl acrylate (EA), and | |
| | | acrylic acid (AA)) | |
| Tetrad-x | Additive | N,N,N′,N′-tetraglycidyl-m- | Mitsubishi |
| | (Thermal | xylenediamine | Gas Chemical |
| | curing agent) | | Company, Inc. |
| CTO-2-2 | Additive | Cesium Tungsten Oxide | CFC |
| | (Near-infrared | dispersion | TERAMATE |
| | ray absorber) | Chemical Formula: CsWO₃ | |
| UV1990 | Additive | Alkyl-[4′-alkylSubstituted- | Eutec |
| | (UV ray | phenylalkene]-alkanedioate | Chemical |
| | absorber) | | Co., Ltd. |
| Panax | Additive | Cyanine-based organic | Ukseung |
| Y-2046 | (Near-infrared | near-infrared ray (760 to | Chemical Co., |
| | ray absorber) | 765 nm) absorbing dye | Ltd. |
| C-ITO | Additive | Indium Tin Oxide dispersion | CFC |
| | (Near-infrared | Chemical Formula: In₂O₃ + | TERAMATE |
| | ray absorber) | SnO₂ | |
| Elvacite | Adhesive | Poly methylmethacrylate | Lucite |
| 2051 | resin | Molecular Weight: 412000 | International |
| | | | Co., Ltd |
| Elvacite | Adhesive | Poly methylmethacrylate | Lucite |
| 2021C | resin | Molecular Weight: 119000 | International |
| | | | Co., Ltd |
| LR TAC | Optical | Low-Reflection Triacetyl | Dai Nippon |
| film | low-reflection | cellulose film | Printing co., |
| | film | | ltd |

### Experimental Examples

### Experimental Example 1—Measurement of Transmittance of Visible Ray and Near-Infrared Ray

For Present Example 1, Present Example 2, Present Example 3, Present Example 4, Comparative Example 1 and Comparative Example 2, transmittance or absorbance of light of a wavelength in each of wavelength bands from 400 nm to 700 nm (visible light) and 700 nm exclusive to 1,500 nm inclusive (near infrared ray) was measured using a UV-Vis-NIR spectrometer (Perkin Elmer, Lambda 1050+). An average value thereof was recorded as transmittance or absorbance of each of visible light and near infrared rays.

### Experimental Example 2—Haze Measurement

For Present Example 1, Present Example 2, Present Example 3, Present Example 4, Comparative Example 1 and Comparative Example 2, the haze in a range (visible light) from 400 nm to 700 nm was measured based on the ASTM D 1003 manner using an NDH-7000 (Haze meter) measuring instrument.

### Experimental Example 3—Environmental Reliability Assessment

The transmittance of each of the visible light and the near-infrared ray and the haze in the visible region as measured in Experimental Examples 1 and 2 were recorded as initial (Ohr) values. After 500 hours and under 85° C./85% RH high temperature and high humidity conditions, transmittance of each of the visible light and the near-infrared ray and haze in the visible region were measured in the same manner as that of each of Experimental Examples 1 and 2. Then, a change in each of the transmittance of each of the visible light and the near-infrared ray and the haze in the visible region was calculated.

Results of Experimental Examples 1 to 3 are shown in Tables 8 and 9 below.

TABLE 8

| | | Examples | | | |
|---|---|---|---|---|---|
| | | Present | Present | Present | Present |
| | | Example | Example | Example | Example |
| | | 1 | 2 | 3 | 4 |
| Transmittance | 0 hr | 88.9 | 88.3 | 87.7 | 88.3 |
| (400 to 700 | 85° C./85% | 87.9 | 87.9 | 87.6 | 87.7 |
| nm) | RH + 500 hr | | | | |
| | Change | −1.0 | −0.4 | −0.1 | −0.6 |
| Transmittance | 0 hr | 19.9 | 11.3 | 15.9 | 18.2 |
| (700 nm | | | | | |
| exclusive to | | | | | |
| 1500 nm | 85° C./85% | 22.9 | 13.5 | 19.9 | 21.2 |
| inclusive) | RH + 500 hr | | | | |
| | Change | +3.0 | +2.2 | +4.0 | +3.0 |
| Haze | 0 hr | 0.7 | 0.9 | 0.7 | 0.7 |
| (400 to 700 | 85° C./85% | 1.2 | 1.2 | 1.4 | 0.7 |
| nm) | RH + 500 hr | | | | |
| | Change | +0.5 | +0.3 | +0.7 | 0.0 |

TABLE 9

| | | Comparative | Comparative |
|---|---|---|---|
| | | Example 1 | Example 2 |
| Transmittance | 0 hr | 88.6 | 86.9 |
| (400 to 700 nm) | 85° C./85% RH + 500 hr | 86.2 | 85.7 |
| | Change | −2.4 | −1.2 |
| Transmittance | 0 hr | 19.4 | 16.4 |
| (700 nm exclusive | 85° C./85% RH + 500 hr | 23.6 | 23.3 |
| to 150 nm | Change | +4.2 | +6.9 |
| inclusive) | | | |
| Haze | 0 hr | 0.7 | 0.7 |
| (400 to 700 nm) | 85° C./85% RH + 500 hr | 6.4 | 3.3 |
| | Change | +5.7 | +2.6 |

As shown in Table 8, the water-vapor barrier layer in the adhesive film for the display of each of Present Examples 1 to 4 had a relatively low water-vapor transmission rate (WVTR). Thus, the haze change value in the environmental reliability evaluation was relatively small. Thus, the adhesive film for the display of each of Present Examples 1 to 4 had heat resistance (heat resistance after wet heating).

In contrast thereto, as shown in Table 9, the adhesive film for the display of each of Comparative Examples 1 and 2 had no water-vapor barrier layer or had a water-vapor barrier layer having a relatively high water-vapor water vapor transmission rate (WVTR) and thus exhibited no heat resistance after wet heating.

When comparing Present Example 4 and Comparative Example 1 having the same adhesive layer with each other, Present Example 4 had a structure in which the first adhesive layer containing tungsten oxide was disposed on the glass substrate, and the water-vapor barrier layer and the second adhesive layer are disposed thereon, whereas Comparative Example 1 had a structure in which positions of the first adhesive layer and the second adhesive layer were reversed. In this regard, the change in each of the transmittance of each of the visible light and the near-infrared ray and the haze in the visible region under high temperature and high humidity conditions was relatively significantly smaller in Present Example 4, compared to that in Comparative Example 1.

When Comparing Present Example 1 and Comparative Example 2 with each other, the adhesive film was divided into the layers and the water vapor transmission rate to tungsten oxide was lowered in Present Example 1, whereas in Comparative Example 2, the additive such as the near-infrared ray blocker was added to the adhesive film as a single layer as in the prior art. In the regard, the change in each of the transmittance of each of the visible light and the near-infrared ray and the haze in the visible region under high temperature and high humidity conditions was relatively significantly smaller in Present Example 1, compared to that in Comparative Example 2.

A scope of protection of the present disclosure should be construed by the scope of the claims, and all technical ideas within the scope equivalent thereto should be construed as being included in the scope of the present disclosure. Although the embodiments of the present disclosure have been described in more detail with reference to the accompanying drawings, the present disclosure is not necessarily limited to these embodiments. The present disclosure may be implemented in various modified manners within the scope not departing from the technical idea of the present disclosure. Accordingly, the embodiments disclosed in the present disclosure are not intended to limit the technical idea of the present disclosure, but to describe the present disclosure. the scope of the technical idea of the present disclosure is not limited by the embodiments. Therefore, it should be understood that the embodiments as described above are illustrative and non-limiting in all respects. The scope of protection of the present disclosure should be interpreted by the claims, and all technical ideas within the scope of the present disclosure should be interpreted as being included in the scope of the present disclosure.

What is claimed is:

1. An adhesive film for a display, the adhesive film comprising:
a first adhesive layer including an adhesive resin;
a water-vapor barrier layer disposed on the first adhesive layer;
a second adhesive layer disposed on the water-vapor barrier layer and including an adhesive resin; and
an optical film disposed on the second adhesive layer,
wherein at least one layer of the first adhesive layer or the water-vapor barrier layer contains at least one tungsten oxide selected from a group consisting of cesium-doped tungsten oxide (CWO; cesium-doped WO₃) and tungsten oxide (WO₃).

2. The adhesive film of claim 1, wherein at least one layer of the water-vapor barrier layer, the second adhesive layer or the optical film has a water-vapor transmission rate (WVTR) of 100 g/m²·day or smaller under 37° C. and 90% RH conditions.

3. The adhesive film of claim 2, wherein the water-vapor barrier layer has the water-vapor transmission rate (WVTR) of 100 g/m² day or smaller under 37° C. and 90% RH conditions.

4. The adhesive film of claim 1, wherein the water-vapor barrier layer further contains a near-infrared ray absorbing dye.

5. The adhesive film of claim 4, wherein the near-infrared ray absorbing dye includes at least one selected from a group consisting of a dimonium dye, a dithiol metal complex dye, a cyanine dye, a phthalocyanine dye, a naphthalocyanine dye, a porphyrin dye, a benzoporphyrin dye, a squarylium dye, an anthraquinone dye, and a croconium dye.

6. The adhesive film of claim 1, wherein at least one of the first adhesive layer, the water-vapor barrier layer or the second adhesive layer further contains indium tin oxide.

7. The adhesive film of claim 1, wherein at least one of the first adhesive layer, the water-vapor barrier layer or the second adhesive layer further contains an ultraviolet (UV) ray absorber.

8. The adhesive film of claim 1, wherein the tungsten oxide is present in a form of nano powders.

9. The adhesive film of claim 1, wherein the adhesive resin of each of the first and second adhesive layers includes at least one selected from a group consisting of a urethane resin, an acrylic resin, an epoxy resin and a silicone resin.

10. The adhesive film of claim 1, wherein the optical film includes one selected from a group consisting a polyethylene terephthalate (PET) film, a triacetyl cellulose (TAC) film, a cycloolefin polymer (COP) film, a polycarbonate (PC) film, a polyethersulfone (PES) film, a polypropylene (PP) film and an acryl film.

11. The adhesive film of claim 1, wherein the adhesive film has transmittance of a near-infrared ray of a wavelength range of 700 nm exclusive to 1500 nm inclusive in a range of 5 to 50%,
wherein the adhesive film has transmittance of visible light of a wavelength range of 400 nm to 700 nm in a range of 80% or greater.

12. The adhesive film of claim 1, wherein the adhesive film has haze in visible light of a wavelength range of 400 nm to 700 nm in a range of 2.0% or smaller.
